(19) United States
(12) Patent Application Publication
(10) Pub. No.: US 2005/0216486 A1
(43) Pub. Date: Sep. 29, 2005

(54) Methods and systems for software release management

(75) Inventors: Alvin Barshefsky, Naperville, IN (US); Murali Ramakrishnan, Naperville, IL (US); Qiwei Xiao, Bolingbrook, IL (US)

Correspondence Address: DUFT SETTER OLLILA & BORNSEN LLC, 2060 BROADWAY, SUITE 300, BOULDER, CO, 80302, US

(73) Assignee: Lucent Technologies Inc.

(21) Appl. No.: 10/810,207

(22) Filed: Mar. 26, 2004

(51) Int. Cl. G06F 17/00

(52) U.S. Cl. 707/100

(57) ABSTRACT

A software release management system and associated methods for improving robustness and reliability of software release processes. Systems and methods hereof help a user identify differences between a current released version of a software product and a local version subset of the software product. For example, in one aspect hereof, a developer may use systems and methods hereof to identify new, deleted or modified files or directories of a software product stored locally in his/her own build storage area relative to the files and directories that comprise the present released version residing in a release storage area. In one aspect, a scan element scans the developer's build storage area to identify files and directories used by the developer. In another aspect, a verification element may compare the files and directories of the build storage area with those of the release storage area to identify differences therebetween.

### BACKGROUND OF THE INVENTION

1. Field of the Invention The invention relates generally to computer software release management and more specifically relates to methods and systems to improve reliability and repeatability of systems and methods used in the software release process.

2. Statement of the Problem

Computer software programs generally undergo a lifecycle wherein developers of the software program create and/or modify the computer program and provide release versions of the computer program to associated test engineering groups, or marketing/sales and distribution groups, or even directly to end users/consumers. A test engineering group may test the received release of a computer program against a specification and, through an iterative process with the development engineers, converge on a particular release sufficiently tested to permit further release to customers or users. A sales and distribution group may be responsible for generating production copies and packaging for the computer software product received from a development group or a testing group. The sales and distribution group then sells the software products directly or through other distribution channels. In like manner, computer software program retailers and distributors, or even end users/consumers of the product, may also be involved in such lifecycle processes where particular releases are received electronically from the developers and packaged and sold to appropriate consumers and users or retrieved directly by end users of the product.

More generally, at various stages of a software product lifecycle a first group or organization may be responsible for generating a next release of the software product to be provided to a second group or organization for utilization, testing, further development, distribution, etc. As used herein, a “release” refers to a fully constructed version of a software product or computer program ready to be installed and/or used by a next group, user or organization. Such a release may consist of a variety of stored files in a variety of appropriate formats, potentially organized in a hierarchical file and directory structure often to reflect particular details of organization of the software product. Such a hierarchy of files and directories may include a wide variety of files and directories utilized by one particular group and other files and directories utilized by other groups in the software lifecycle processes.

As presented herein, the systems and processes for software release are often discussed in terms of a “developer” or “developer group” working to modify or enhance a software product. Those of ordinary skill in the art will recognize that any individual or group involved in the software release process may encounter the issues and problems presented herein. Product test engineers or groups, sales and marketing engineers or groups, etc. may all be involved in aspects of a software product development lifecycle. Any of these groups or individuals may therefore be referred to as a “developer” or “developer group”.

It is common in such software lifecycle processes for one group (e.g., a developer or development group) to concern itself only with particular files relevant to its participation in the product lifecycle. For example, development engineers may focus on files and directories that relate specifically to source and object code and associated configuration files for the software product. By contrast, a documentation or technical writing group may be focused exclusively on documentation related files and directories. Still other technical writers or supervisory personnel may focus attention on particular files and folders relating to administration and supervision of the software product release such as establishing schedules and monitoring progress on those schedules. Or, for example, a software product testing group may not be concerned with the source code design of the product but rather the executable files and various test procedure files for performing test sequences on the executable software product.

Still further, even within the software product development group, a first group of development engineers may be focused on a particular subset of files and directories of the product that pertain to particular features or functionality of the product. Another development engineering group may focus its attention on other files and directory structures more closely associated with its particular program features or functions. Each development engineering group may therefore access only the files and directories relevant to its particular features and functions of interest.

Generation of a proper release of the software product is largely a manual process as presently practiced. Each developer or developer group, testing group, documentation group, etc. may have its own private collection of files and directories copied from the released product that relate to its particular role in the software lifecycle. Each of these private collections of files must be merged or integrated with the other files that comprise the standard released software product when the desired changes are to be added to a new release of the product.

Each engineer or user of a private collection of files may be said to work in a build area or development area typically populated only with files relevant to the particular feature and function presently being addressed by the associated developer or group. The build area or development area may simply be a portion of the enterprise storage capacity usable by the developer or development group. Typically a separate area or portion of the enterprise storage capacity may be dedicated to an archive for releases of the software product. This storage area for archiving of a release may be referred to as a release area.

In a software product development environment, when a developer has completed work on a new or modified feature, the developer may move, copy or merge the new program related files with those of a previous (i.e., most recent) release of the software product. Where, for example, a developer modifies a relatively small subset of files or directories saved locally in the developer's build area, the integration or merging process with the released software product is at present a largely manual process. For example, the developer would have to compare a list of files and directories in his personal build area with the entire list of files and directories intended for the product release and identify any differences therebetween. The differences to be identified may include identifying files or directories that no longer exist such as where the developer's efforts eliminated one or more files or directories. The differences may also include identifying new files or directories created by the developer's efforts such as where the developer's efforts add new features in corresponding new files or directories. Further, installation of files and directories of a released software product may include proper setting of various attributes or parameters of a file or directory. Such attributes or parameters may include ownership information as well as access control information. Detecting differences in these file and directory attributes may also be critical to the process of merging the developer's build area files and directories with the released files. As noted, at present, such processes are largely manual and hence both time consuming and prone to error.

A wide variety of existing, commercially available software product release management tools permit automated archiving of the files and directories associated with each release of a software product. However, none of the presently known software development and release management tools provide the comprehensive processing required to avoid the potential for such human errors in merging files and directories in local build areas with the corresponding files and directories in a release storage area. A developer may easily overlook the fact that particular files were added or deleted by his/her designed efforts and need to be properly accounted for in the new release. As importantly, a developer may overlook various attributes or parameters associated with a file or directory intended to be copied to the release storage area. Such attributes or parameters may be required to permit proper operation of the software product.

FIG. 1 shows typical processing flow 100 in a software product development lifecycle as presently practiced in the art. Source code control 102 represents typical features for archiving specific snapshots of computer program source code. Such a tool is commonly applied by computer program developers and is well known to those of ordinary skill in the art. Source code control tools are generally commercially available from a number of software vendors. For example, RCS and SCCS are common source code control programs that are common in many distributions of UNIX and Linux systems.

A computer program developer utilizes source code control 102 for getting or copying information from the source code control element 102 and by saving information into the source code control element 102. The copied information is generally stored within a source code work area 104 utilized by the developer. Arrow 103 indicates the exchange of information between the source code work area 104 and source code control 102. The developer works on programs source code work area 104 editing, compiling, linking and debugging the computer programs as indicated by arrow 105. Standard programming tools for editing, compiling, linking and debugging a software product are well known to those of ordinary skill in the art and generally included as standard features in, for example, Linux system distributions. The software product developed and built for testing by the developer using such processes typically resides in a build area 106. Release area 108 is an area of storage where a present version of the released software product resides.

Manual release procedures 107 are, at present, used for updating the release area 108 with new program files from build area 106. Such totally manual procedures are both prone to error and may be time consuming. For example, as noted above, the developer may inadvertently neglect to copy a particular file from the build area 106 to the release area 108. Such an error may frequently occur simply due to human oversight exacerbated by the complexity of large software products involving hundreds or thousands of related files and directories.

It is evident from the above discussion that a need exists for improved software release management to reduce the potential for such human errors.

### SUMMARY OF THE SOLUTION

The invention solves the above problems and other problems with improved software release management methods and systems. Methods and systems of the invention provide computer assistance to the previously totally manual processes for integrating changes of a software product into a released version of the product to generate a new release. As compared to prior totally manual processes, the computer assistance methods and systems hereof reduce the potential for human error and reduce the time required for human intervention in so integrating changes in a software product into a new release. More specifically the methods and systems aid a user in creating a new release by identifying differences between files and directories modified in creating a potential new release and the files and directories that make up a current release of the software product. Automatically identifying the differences helps reduce human errors such as failing to recognize or recall which files and directories have been modified. The user may then proceed with the process of updating a current release with modified files and directories to generate a new release. As compared to prior techniques, the user proceeds with higher confidence that all expected differences will be properly integrated and that all unexpected differences have been corrected in creating the new release.

One aspect hereof provides a system comprising: a release storage area for storing files and directories related to a current release of a released software product; a second storage area for storing files and directories associated with modifications of the current release; a software release information manager coupled to the release storage area and coupled to the second storage area and adapted to identify differences between files and directories in the release storage area and files and directories in the second storage area.

Aspects hereof may also provide that the software release information manager further comprises: a scan element to determine information regarding files and directories located in the second storage area.

Aspects hereof may also provide that the software release information manager further comprises: a database coupled to the scan element for storing the information regarding files and directories located in the second storage area.

Aspects hereof may also provide that the software release information manager further comprises: a verify element to compare information associated with files and directories in the release storage area with information associated with the files and directories in the second storage area to identify differences between the compared information.

Aspects hereof may also provide that the software release information manager further comprises: an install element to copy files and directories from the second storage area to the release storage area.

Aspects hereof may also provide that the second storage area is a build storage area used by a developer to modify or create files and/or directories for the software product.

Aspects hereof may also provide that the identified differences may include one or more of: file existence, file naming, file ownership information, file access control information, file contents, directory existence, directory naming, directory ownership information, and directory access control information.

Another aspect hereof provides a method for software release management of a software product, the method comprising the steps of: identifying a build storage area having development files in a hierarchically structured development directory; gathering build information regarding development files and directories in the build storage area; identifying a release storage area having release files in a hierarchically structured release directory; gathering release information regarding the release files and directories in the release storage area; and reporting to a user regarding differences between the release information and the build information wherein the differences include one or more of: file existence, file naming, file ownership information, file access control information, file contents, directory existence, directory naming, directory ownership information, and directory access control information.

Aspects hereof may also provide that the method further comprises: storing the gathered build information in a database; and storing the gathered release information in a database, wherein the step of reporting further comprises accessing the database to compare the build information stored therein and the release information stored therein to identify differences therebetween.

Aspects hereof may also provide that the method further comprises: installing a copy of the release files and directories in a destination storage area to install a current release of the software product.

Aspects hereof may also provide that the method further comprises: copying build files from the build area to the release area to generate a new release.

Aspects hereof may also provide that the method further comprises: installing a copy of the release files and directories in a destination area to install the new release of the software product.

Another aspect hereof provides a method for software release management comprising the steps of: scanning a build storage area that contains modified files and directories for a software product; generating an inventory file from build information derived from the step of scanning and regarding the modified files and directories in the build storage area; verifying the build information in the inventory file with release information regarding a current release of files and directories in a release storage area; and installing modified files and directories in the release storage area to create a new release of files and directories in the release storage area.

Aspects hereof may also provides that the release information is stored in a release database.

Aspects hereof may also provide that the method further comprises: updating information in the release database from the build information in the inventory file in response to the step of installing modified files and directories.

Aspects hereof may also provide that the step of verifying comprises: identifying the differences between the build storage area and the release storage area; and presenting the identified differences to a user to permit correction of any identified anomalies by the user.

Aspects hereof may also provides that the differences may include one or more of: file existence, file naming, file ownership information, file access control information, file contents, directory existence, directory naming, directory ownership information, and directory access control information.

### BRIEF DESCRIPTION OF THE DRAWINGS

The same reference number represents the same element on all drawings.

FIG. 1 illustrates a system and process flow of software release management as presently practiced in the art.

FIG. 2 illustrates an exemplary system and process flow of software release management as enhanced in accordance with features and aspects hereof.

FIG. 3 is a block diagram of an exemplary system in which features and aspects hereof may be beneficially applied.

FIG. 4 is a flowchart describing an exemplary method for scanning/importing information regarding updates to a software product in accordance with features and aspects hereof.

FIG. 5 is a flowchart describing an exemplary method for verifying information regarding updates to a software product in accordance with features and aspects hereof.

FIG. 6 is a flowchart describing an exemplary method for installing updates to a software product in accordance with features and aspects hereof.

### DETAILED DESCRIPTION

For the purpose of teaching inventive principles in the following discussion, some conventional aspects of the invention have been simplified or omitted. Those skilled in the art will appreciate variations from these embodiments that fall within the scope of the invention. Those skilled in the art will appreciate that the features and aspects described below can be combined in various ways to form multiple variations of the invention. As a result, the invention is not limited to the specific embodiments described below, but only by the claims the follow and their equivalents.

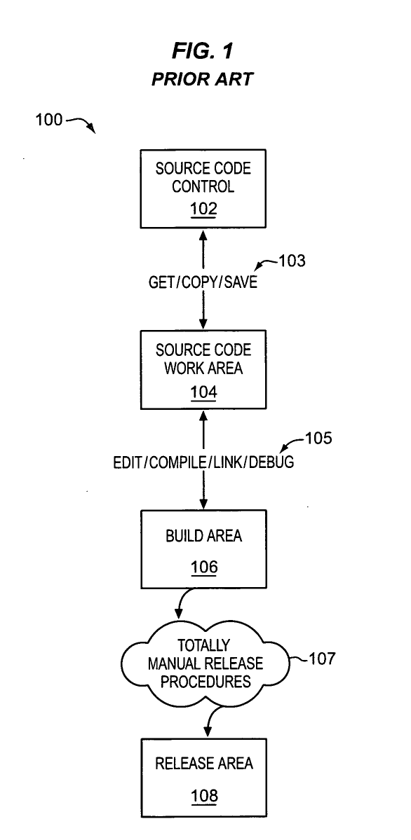

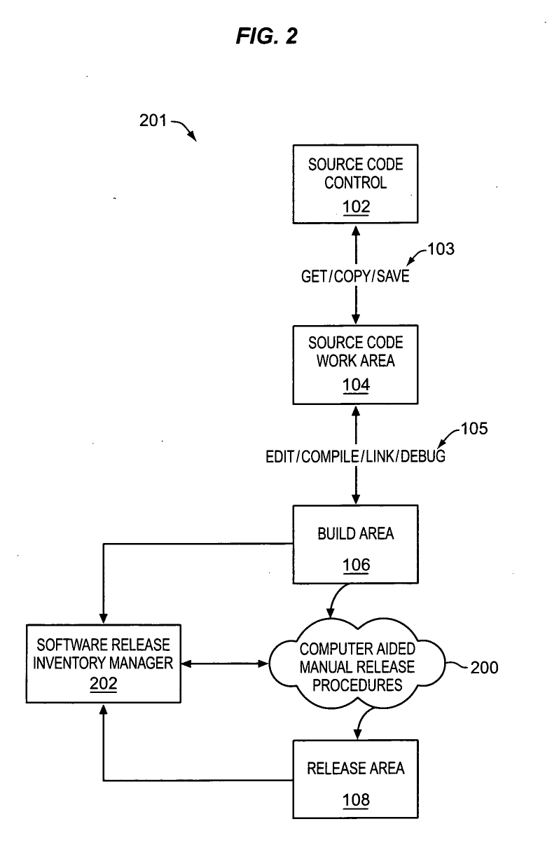

FIG. 2 is a block diagram showing structures and procedures (201) for release management similar to that of FIG. 1 but enhanced with the software release information manager 202 and associated computer aided manual release procedures 200 in accordance with features and aspects hereof. As above, with respect to FIG. 1, in FIG. 2 a developer may utilize source code control 102 to get/copy/save (103) program source code exchanged with source code work area 104. The developer then edits/compiles/links/debugs (105) modifications to the source code in source code work area 104 for testing the new features of the program product in build area 106. Ultimately, as above with respect to FIG. 1, FIG. 2 shows release area 108 adapted for storing a present released version of the software product including all files and any hierarchical directory structures associated with those files as normally installed according to the needs of the software product.

In contrast with presently practiced software product release management as described above in FIG. 1, FIG. 2 shows computer aided manual release procedures 200 as distinct from totally manual procedures described above. Although the process of creating a new release in release area 108 based upon the changes built and tested in build area 106 still involves some manual processing, features and aspects hereof partially automate the process by helping the user identify the differences between a new version built in build area 106 and a current released version in release area 108. Software release information manager 202 (“SRIM”) provides computer assistance for the computer aided manual release procedures 200. More specifically, a user performing the computer aided manual release procedures 200 utilizes SRIM 202 to help identify both intended and unintended differences between the software product built in build area 106 and the present released software product residing in release area 108. As discussed further herein below, analysis of such differences may include identifying changes in file names or directory names, addition or deletion of files or directory, changes in file or directory attributes and parameters such as owner identification and permission information, time stamp information indicating a date and/or time of last edit/build, a release version index number, platform related information (i.e., operating system type and version as well as host computer name or address) and digital signature information to help identify changes in the contents of the particular files.

SRIM 202 may include files and databases for storing attributes and parameters of the various files that comprise a present release of the software product. Further, SRIM 202 may interact with the developer/user to simplify analysis of information and comparison of the information to that of a present software product release. SRIM 202 retrieves information regarding the developer's build area 106 and also retrieves information regarding a present release in release area 108 for purposes of aiding the user in release procedures 200. As discussed further herein below, in response to a user's request, SRIM 202 may compare files and directories in build area 106 with those in release area 108 to help the user identify the differences between the software product presently built in building area 106 and that of the current release in release area 108. Thus the user performing release procedures 200 may more reliably identify changes that are intended and differences that are unintended. SRIM 202, in conjunction with the manual procedures 200, improves the robustness and reliability of otherwise totally manual release procedures as presently practiced. Unintended differences may be corrected before a next new release is entered into releasing area 108 to thereby reduce potential errors at in a next released version.

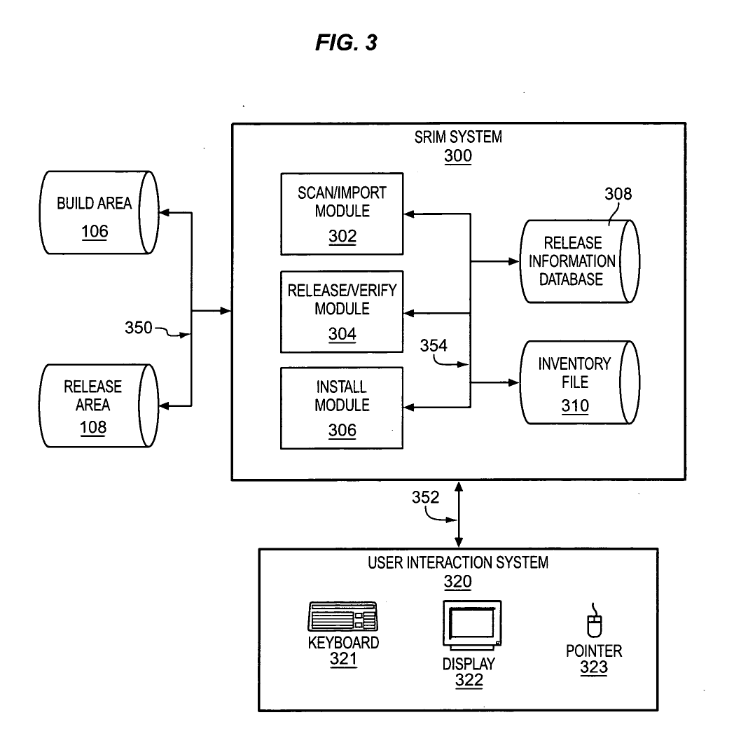

FIG. 3 is a block diagram describing an exemplary structure of SRIM system 300 operable to interact with a user to update the current release of a software program product. SRIM system 300 may be any typical computing node including, for example, a server, personal computer or WorkStation in which elements of the software release information management system may be operable. A processor and memory (not shown) in system 300 may perform SRIM functional elements such as scan/import module 302, release/verify module 304 and install module 306. SRIM system 300 may interact with the user (i.e., a software developer or administrator) through user interaction system 320 over path 352. User interaction system 320 may include typical user interface components such as keyboard 321, display 322 and pointer/mouse 323. The user interaction system 320 may be implemented as user interface elements coupled to SRIM system 300 or may be implemented as an additional computing node such as a WorkStation or personal computer coupled to SRIM system 300 through networking features over path 352. Those of ordinary skill in the art will recognize a wide variety of such configurations for providing user interface capabilities associated with the functional elements shown within SRIM system 300.

SRIM system 300 may store and retrieve information on behalf of the user in build area 106 and release area 108 via path 350. Those of ordinary skill in the art will recognize that SRIM system 300 may be coupled to storage areas (e.g., build area 106 and release area 108) via direct local attachment such as SCSI or IDE or may be coupled through networking storage features to provide shared, network access to build area 106 and release area 108. These and other architectures for coupling SRIM system 300 to related storage areas are well known as matters of design choice for those of ordinary skill in the art. Release information database 308 and inventory file 310 are generally accessible only to the SRIM system 300 and may be coupled thereto through path 354 by any well known local or remote storage attachment media and protocol. Functional elements and 302, 304 and 306 manipulate information in release information database 308 and inventory file 310 via path 354. Further details regarding methods for accessing such information are discussed herein below.

Those of ordinary skill in the art will recognize a wide variety of computing and network architectures useful for providing software release information management features and aspects hereof. Functional elements 302 through 306 in SRIM system 300 may be implemented as functions integrated within a software development suite of tools or may be abstracted into distributed services provided by SRIM system 300 as a server node accessible by other client processes through appropriate network and distributed programming structures and concepts well known to those of ordinary skill in the art. The structure of FIG. 3 is therefore intended merely as exemplary of one possible structure providing features and aspects hereof to improve software released management.

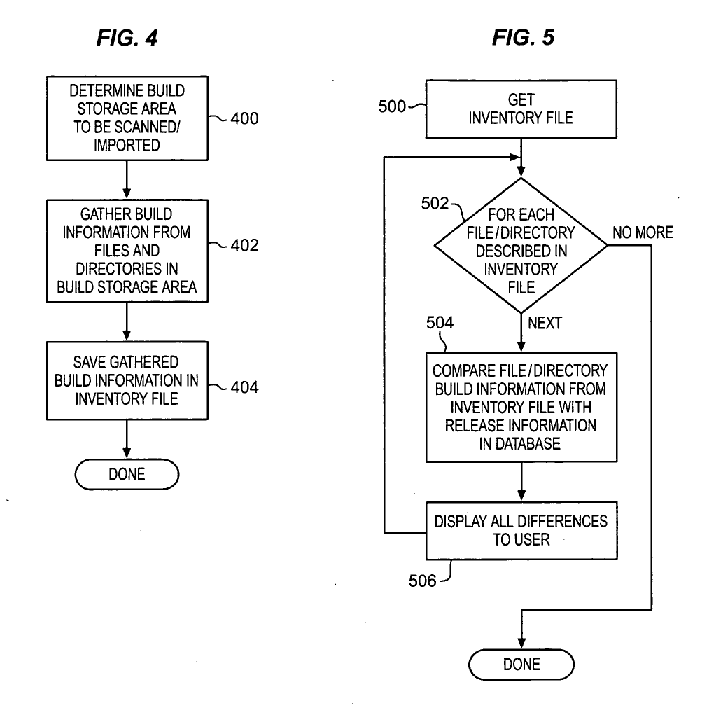

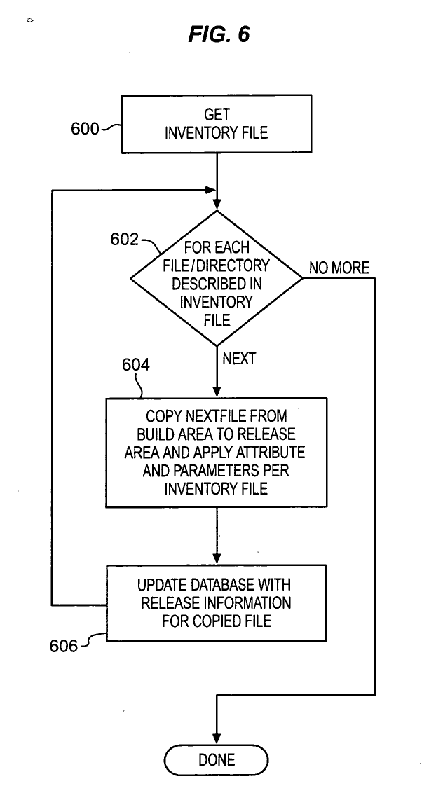

FIGS. 4 through 6 are flowcharts describing operation of exemplary functional elements of SRIM system 300 discussed above with respect to FIG. 3. In particular, FIG. 4 represents exemplary processing for scan/import module 302 as discussed above in FIG. 3. FIG. 5 represents exemplary processing for release/verify module 304 discussed above with respect to FIG. 3. FIG. 6 represents exemplary processing for an install module 306 as discussed above with respect to FIG. 3.

In particular, referring to FIG. 4, element 400 is first operable to determine the build storage area to be scanned or imported in response to a user's request. In general, a developer/user will complete design of enhancements or modifications to the software product and then, in accordance with features and aspects hereof, request a scan for purposes of preparing to install the new features in a new release of the software product. Element 402 then performs the desired scan of the identified build area to gather build information from the files and directories located in the identified build storage area. The scan operations performed by element 402 are operable to gather build information identifying files and directories located in the identified build storage area and to gather build information identifying attributes and parameters of all such located files and directories. The build information so gathered may include, for example: file/directory naming, time stamp information relative to changes or creation in identified files/directories, access control information for identified files/directories, ownership information for identified files/directories, etc.

All build information so gathered by operation of element 402 may then be saved in an inventory file structure by operation of element 404. The inventory file structure therefore contains all information useful to identify changes and enhancements created in the developer's build storage area. As discussed further herein below, the inventory file generated by such a scan/import process is used later to help the user verify the intended update and to actually perform the intended update of the release area.

Having performed such a scan or import process as described in FIG. 4, a user may then request verification of the intended new release. Element 500 retrieves the inventory file generated by an earlier scan/import process as described above in FIG. 4. Elements 502 through 506 are then iteratively operable for each file/directory identified in the inventory file as having been located in the user's build storage area. When element 502 determines that all such identified files/directories have been processed, the method completes. Otherwise, element 504 compares the build information in the inventory file for a next file/directory in the user's build area with corresponding information in the release information database. As discussed further herein below, the release information database is updated any time a new release is created in the release storage area to reflect current information regarding all files and directories in the newly created release. Element 504 therefore compares information regarding each file or directory located in the user's build storage area with the corresponding information for the present release. Element 506 then displays for the user all differences identified by the comparison performed in element 504. The differences are displayed for the user to permit the user to determine whether the identified differences are intended changes for the new release or unintended differences to be corrected before the new release is created. Processing then continues looping back to element 502 to process additional files or directories described in the inventory file.

As noted above, the differences between the user's build area and the current release area are presented to the user to permit the user to determine which differences are intended changes versus unintended errors. This information permits the user to avoid introducing errors into a new release through simple oversights in the name, ownership, permission, etc. for one or more files in the intended new release. Confronted with a list of the identified differences, the user determines manually which differences are intended changes and which are unintended possible errors. Those differences that represent possible errors are corrected by the user and a new scan/import operation may be requested.

When a user is satisfied that the unintended differences that may represent possible errors have been eliminated, the user may invoke the process of FIG. 6 to install the new release into the current release storage area (i.e., to update the current release with the new release files and directories). Element 600 is first operable to retrieve the inventory file created as above in FIG. 4 and verified as above in FIG. 5. Elements 602 through 606 are then iteratively operable to process each file/directory identified in the inventory file. When element 602 determines that no further files remain to be processed, the method completes. Otherwise, element 604 is operable to copy the next modified/new file/directory identified in the inventory file into the identified release area. File attributes and parameters of the new/modified file so copied are also set as indicated in the inventory file to that intended by the developer/user. Element 606 then updates the release database with the new information regarding the newly created/modified file just copied to the release area. The updated information in the release database is then used in any subsequent comparison/verification performed as above with respect to FIG. 5. Processing then continues looping back to element 602 until all files/directories identified in the inventory file have been processed.

The following exemplary files/directories exhibit a typical software product and operation of release management processes in accordance with features and aspects hereof. A product (“product_a”) is stored in its current release form in a release area as follows (exemplary parameters and attributes of the files are provided in parenthetic notes following a file):

RELEASE AREA:

| | |
|---|---|
| /rel/product_a | /* root of product release area */ |
| /rel/product_a/home | /* a directory storing a home web page * |
| /rel/product_a/home/index.asp | /* the home page of the product */ |

(owner=user1.group1, permissions=rrr, signature=<signature1>)

| | |
|---|---|
| /rel/product_a/module1 | /* another directory storing related web pages */ |
| /rel/product_a/module1/yyy.asp | /* another web page of the product */ |

(owner=user1.group1, permissions=rrr, signature=<signature2>)

| | |
|---|---|
| /rel/product_a/module1/zzz.asp | /* another web page of the product */ |

(owner=user1.group1, permissions=rrr, signature=<signature3>)

| | |
|---|---|
| /rel/product_a/help | /* another directory storing help information */ |
| /rel/product_a/help/help1.doc | /* help information for the product */ |

(owner=user1.group1, permissions=rrr, signature=<signature4>)

A developer (“user2”) creates new features by removing a page (“zzz.asp”) and adding new image files (“bbb.gif” and “ccc.gif”). As is common for a developer, only the files to be altered may be present in his build area as follows:

USER2 BUILD AREA:

| | |
|---|---|
| /user2/product_a | /* user2's root folder */ |
| /user2/product_a/home | /*user2's home folder for changed files */ |
| /user2/product_a/home/index.asp | /* the home page of the product */ |

(owner=user1.group1, permissions=rrr, signature=<signature1>)

| | |
|---|---|
| /user2/product_a/module1 | /* another directory storing related web pages */ |
| /user2/product_a/module1/yyy.asp | /* user2's modified web page of the product */ |

(owner=user2.group1, permissions=wrr, signature=<signature2a>)

| | |
|---|---|
| /user2/product_a/module1/bbb.gif | /* user2's added image for the product */ |

(owner=user2.group1, permissions=rrr, signature=<signature5>)

| | |
|---|---|
| /user2/product_a/module1/ccc.gif | /* user2's added image for the product */ |

(owner=user2.group1, permissions=rrr, signature=<signature6>)

Of note in the build is that user2 did not include any files in the help directory nor the help directory per se. Further, of note is that the signature, owner and permission parameters for existing file “yyy.asp” have been altered by user2's work thereon. Still further, file “zzz.asp” has been removed by user2 and files “bbb.gif” and “ccc.gif” have been added. A scan/import operation performed by user2 will create an inventory file having information as above relating to files/directories in user2's build area.

A verify operation requested by user2 may report the following differences to user2:

```
FILES IN CURRENT RELEASE NOT IN NEW BUILD:
product_a/module1/zzz.asp
product_a/help
product_a/help/help1.doc
NEW FILES IN NEW BUILD AND NOT IN CURRENT RELEASE:
product_a/module1/bbb.gif
product_a/module1/ccc.gif
DIFFERENCES IN PARAMETERS OF FILES IN BOTH:
product_/module1/yyy.asp
  NEW PARAMETERS:
    (owner=user2.group1, permissions=wrr, signature=<signature2a>)
  RELEASED PARAMETERS:
    (owner=user1.group1, permissions=rrr, signature=<signature2>)
```

Presented with such a report of the differences, user2 may determine which differences are intended changes and which are unintended differences and hence possible errors. Those of ordinary skill in the art will recognize that the exemplary files and directories discussed above are merely presented to help the reader in understanding the structures and methods associated with features and aspects hereof. Numerous other exemplary file/directory examples and associated report formats will be readily apparent to those of ordinary skill in the art.

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. In particular, those of ordinary skill in the art will readily recognize that features and aspects hereof may be implemented equivalently in electronic circuits or as suitably programmed instructions of a general or special purpose processor. Such equivalency of circuit and programming designs is well known to those skilled in the art as a matter of design choice. As a result, the invention is not limited to the specific examples and illustrations discussed above, but only by the following claims and their equivalents.

1. A system comprising:
a release storage area for storing files and directories related to a current release of a released software product;
a second storage area for storing files and directories associated with modifications of the current release;
a software release information manager coupled to the release storage area and coupled to the second storage area and adapted to identify differences between files and directories in the release storage area and files and directories in the second storage area.

2. The system of claim 1 wherein the software release information manager further comprises:
a scan element to determine information regarding files and directories located in the second storage area.

3. The system of claim 2 wherein the software release information manager further comprises:
a database coupled to the scan element for storing the information regarding files and directories located in the second storage area.

4. The system of claim 1 wherein the software release information manager further comprises:
a verify element to compare information associated with files and directories in the release storage area with information associated with the files and directories in the second storage area to identify differences between the compared information.

5. The system of claim 1 wherein the software release information manager further comprises:
an install element to copy files and directories from the second storage area to the release storage area.

6. The system of claim 1 wherein the second storage area is a build storage area used by a developer to modify or create files and/or directories for the software product.

7. The system of claim 1 wherein the identified differences may include one or more of: file existence, file naming, file ownership information, file access control information, file contents, directory existence, directory naming, directory ownership information, and directory access control information.

8. A method for software release management of a software product, the method comprising the steps of:
identifying a build storage area having development files in a hierarchically structured development directory;
gathering build information regarding development files and directories in the build storage area;
identifying a release storage area having release files in a hierarchically structured release directory;
gathering release information regarding the release files and directories in the release storage area; and
reporting to a user regarding differences between the release information and the build information wherein the differences include one or more of: file existence, file naming, file ownership information, file access control information, file contents, directory existence, directory naming, directory ownership information, and directory access control information.

9. The method of claim 8 further comprising:
storing the gathered build information in a database; and
storing the gathered release information in a database,
wherein the step of reporting further comprises accessing the database to compare the build information stored therein and the release information stored therein to identify differences therebetween.

10. The method of claim 8 further comprising:
installing a copy of the release files and directories in a destination storage area to install a current release of the software product.

11. The method of claim 8 further comprising:
copying build files from the build area to the release area to generate a new release.

12. The method of claim 11 further comprising:
installing a copy of the release files and directories in a destination area to install the new release of the software product.

13. A method for software release management comprising the steps of:
scanning a build storage area that contains modified files and directories for a software product;
generating an inventory file from build information derived from the step of scanning and regarding the modified files and directories in the build storage area;
verifying the build information in the inventory file with release information regarding a current release of files and directories in a release storage area; and
installing modified files and directories in the release storage area to create a new release of files and directories in the release storage area.

14. The method of claim 13 wherein the release information is stored in a release database.

15. The method of claim 14 further comprising:
updating information in the release database from the build information in the inventory file in response to the step of installing modified files and directories.

16. The method of claim 13 wherein the step of verifying comprises:
identifying the differences between the build storage area and the release storage area; and
presenting the identified differences to a user to permit correction of any identified anomalies by the user.

17. The method of claim 16 wherein the differences may include one or more of: file existence, file naming, file ownership information, file access control information, file contents, directory existence, directory naming, directory ownership information, and directory access control information.
